(19) United States
(12) Patent Application Publication
(10) Pub. No.: US 2021/0241399 A1
(43) Pub. Date: Aug. 5, 2021

(54) METHOD AND SYSTEM FOR LEASING AND TRANSFERRING REAL ESTATE

(71) Applicant: Gerald Evans, Soehlde (DE)

(72) Inventor: Gerald Evans, Soehlde (DE)

(21) Appl. No.: 17/164,980

(22) Filed: Feb. 2, 2021

Related U.S. Application Data
(60) Provisional application No. 62/969,563, filed on Feb. 3, 2020.

(51) Int. Cl. G06Q 50/16; G06Q 50/18; G06Q 30/06

(52) U.S. Cl. CPC G06Q 50/165; G06Q 30/0645; G06Q 50/188; G06Q 50/163

(57) ABSTRACT

Methods and systems for leasing and transferring real estate are provided. The methods and systems are configured to allow a customer to select one or more parcels of real estate owned by a real estate owner or by an investor, and develop the selected parcels if needed or desired. The methods and systems further comprise executing a lease-contract and a real estate transfer contract by the customer and investor, the lease-contract providing that the investor conveys a leasehold to the customer for the parcel(s) of real estate and the real estate transfer contract providing that the real estate transfer contract is not valid unless one or more condition precedents are satisfied. The real estate transfer contract becomes effective due to the condition precedent of the full price being paid through lease payments being paid by the customer.

### CROSS-REFERENCE TO RELATED APPLICATION

This application claims the benefit of U.S. Provisional Patent Application No. 62/969,563, filed Feb. 3, 2020, which is hereby incorporated by reference in its entirety.

### TECHNICAL FIELD

As discussed in more detail below, the present disclosure provides methods and systems for leasing and transferring real estate.

### BRIEF DESCRIPTION OF THE DRAWINGS

FIG. 1 shows a diagram of parties of methods and systems for leasing and transferring real estate in accordance with the present disclosure;

FIG. 2 shows a flow diagram of an exemplary method for leasing and transferring real estate in accordance with the present disclosure; and

FIG. 3 shows a diagram of a computer system for leasing and transferring real estate in accordance with the present disclosure.

### DETAILED DESCRIPTION

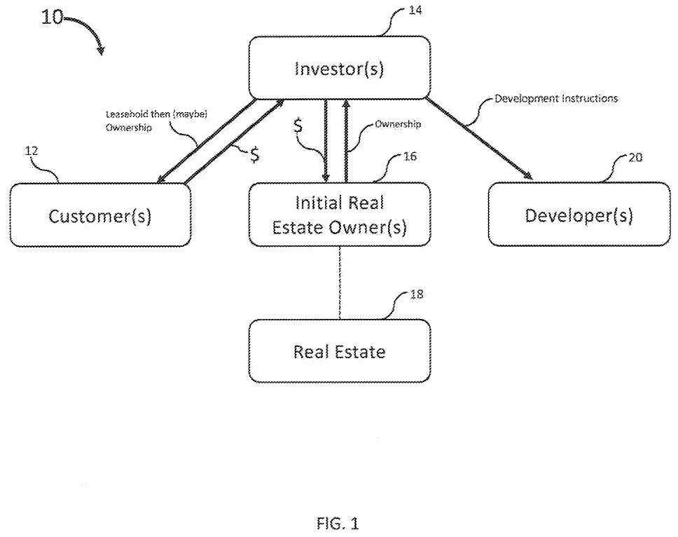

Referring to FIG. 1, a diagram 10 of a parties participating in the method and system for leasing and transferring real estate is shown in accordance with embodiments of the present disclosure. The parties include the customer(s) 12, the investor(s) 14, the initial real estate owner(s) 16 that own one or more parcels of real estate 18, and the developer(s) 20 that receive instructions or orders from the investor(s) 14. The parties may be natural persons or corporate entities, or any combination thereof. For example, the customer(s) 12 may be natural persons, the investor(s) 14 may be limited liability companies (LLC) or corporations and the initial real estate owner(s) 16 may be natural persons. There may be any quantity of any party 12, 14, 16, 20, but for the sake of simplicity the parties 12, 14, 16, 20 will described hereinafter in the singular form. In some embodiments, the developer 20 and the investor 14 are one and the same, or the developer 20 is a part of the organization or corporation that constitutes the investor 14.

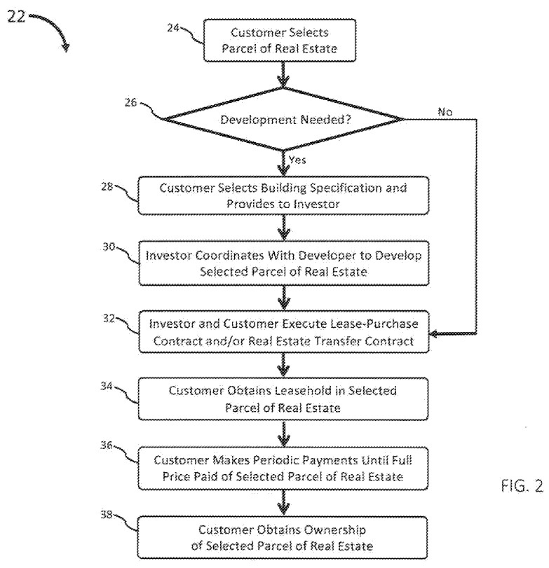

Referring to FIG. 2, a flow diagram 22 of an exemplary method according to the present disclosure is shown. The method begins at block 24 where the customer 12 selects one or more parcels of real estate 18 owned by the real estate owner 16 and provides this selection to the investor 14. The investor 14 may also assist the customer 12 in selecting the one or more parcels of real estate 18. At block 26, it is determined whether or not development of the selected parcel(s) of real estate 18 is needed or desired. If development is needed or desired, at block 28, the customer 12 further selects a building specification suitable for building on the selected parcel of real estate 18 and provides this selection to the investor 14. In general, the one or more parcels of real estate 18 may be undeveloped parcel(s) of real estate, so that development is required. The investor 14 may provide the customer 12 with a catalogue of suitable building specifications from which the customer 12 may select a building for the selected one or more parcels of real estate 18. In some embodiments, the investor 14 transacts with the initial real estate owner 16 in order to acquire ownership of the selected parcel of real estate 18. In some embodiments, the investor 14 may have already acquired the selected parcel of real estate 18 from the initial real estate owner 16 before the customer 12 has made the selection.

At block 30, after acquiring ownership of the selected parcel of real estate 18, the investor 14 coordinates with the developer 20 to develop one or more buildings on the selected parcel of real estate 18 that is built according to the selected building specification or substantially according to the selected building specification, or to conform one or more existing buildings according to the building specification or substantially according to the building specification (collectively “development”).

In some embodiments, the building to be developed is a single-family house. In these embodiments the method and system for leasing and transferring real estate may, if authorized by the trademark owner(s), be marketed under the trademarks GECCI or GECCI Rent & Buy. In some embodiments, the building to be developed is a condominium or an apartment or an apartment building. In these embodiments the method and system for leasing and transferring real estate may, if authorized by the trademark owner(s), be marketed under the trademarks GECCI or GECCI Living. In still further embodiments, the building to be developed is a city block or an entire or part of a city quarter. Furthermore, the building to be developed may be commercial real estate.

Before or after the development of the building(s) on the selected parcel of real estate 18, at block 32, the customer 12 and the investor 14 execute a lease-contract and a real estate transfer contract. The lease-contract and the real estate transfer contract may be executed contemporaneously (or substantially contemporaneously) and the real estate transfer contract provides that the real estate transfer contract is not valid (or does not come into effect) unless one or more condition precedents are satisfied. In some embodiments, the lease-contract provides an agreement to execute the real estate transfer contract at a later date if one or more condition precedents are satisfied. In some embodiments, the execution of the contracts may happen before or during the development occurring at block 30. The lease-contract and the real estate transfer contract may be separate contracts in separate documents to be signed individually or the lease-contract and the real estate transfer contract may be joint contracts in a single document to be signed collectively. In some embodiments the real estate transfer contract does not specify a final payment for the real estate transfer contract to come into effect. Thus, in these embodiments the real estate transfer contract is not configured as a contract to purchase real estate nor does the real estate transfer contract comprise provisions typical or indicative of a contract to purchase real estate.

The lease-contract provides that the investor 14 conveys a leasehold to the customer 12 for the selected parcel of real estate 18, including one or more of the buildings that have been developed, are being developed or will be developed. The leasehold duration may be indefinite or for a particular duration of time. The lease-contract provides that the customer 12 promises to pay the investor 14 (or entity of the investor's 14 choosing) periodic lease payments during the duration of the leasehold, or during the particular duration of time. For example, periodic lease payments may be weekly, monthly, or yearly payments. The duration of time may be any duration of time such as between 23 and 32 years, or the duration of time may be 15 years, 20 years, or 35 years.

In some embodiments, the lease-contract provides that the investor 14 conveys a right to sub-lease the selected real estate parcel 18 to a third party via a sub-lease agreement.

In some embodiments, the lease-contract provides that the leasehold to the customer 12 terminates if the customer 12 terminates or breaches the contract (e.g. through failure to make promised payment(s)) and the customer 12 loses all rights concerning the selected parcel of real estate 18 (or loses substantially all rights concerning the selected parcel of real estate 18 or surrenders all rights allowed by law in the applicable jurisdiction(s)).

The lease-contract may provide for a plurality of other conditions, promises and/or conveyances. For example, the lease-contract may provide that utility costs for the selected parcel of real estate 18 are fixed and the customer 12 promises to pay the fixed utility costs, or the utility costs are subject to an inflation rate or other metric for higher/lower utility costs.

In some embodiments, the investor 14 has no possibility to terminate the lease-contract and/or the real estate transfer contract as long as the customer 12 is making the promised payments at the promised times.

In some embodiments, the lease-contract and/or the real estate transfer contract provides that a priority notice of conveyance for the benefit of the customer 12 is entered in the land register. The priority notice of conveyance may be registered with a waiver of objection and and/or a waiver of the plea of lapsed time. With the priority notice of conveyance the customer 12 may be protected against insolvency of the investor 14 and/or the developer 20. The priority notice of conveyance also prohibits the investor from selling or leasing the real estate 18 to a third person, thus providing additional insurance to the customer 12.

Following execution of the contract(s), at block 34, the customer 12 obtains the leasehold in the selected parcel of real estate 18 as outlined in the lease-contract provisions. Then, at block 36, the customer 12 makes the promised payments until the full price of the selected parcel of real estate 18 is paid, including any applicable interest or fees. Then, at block 38, the real estate transfer contract becomes effective due to the condition precedent of the full price being paid through lease payments being paid and the customer 12 acquires ownership of the selected parcel of real estate 18 including the one or more of the buildings that have been developed.

The ownership of the selected real estate parcel 18 remains with the investor 14 until the price for the selected real estate parcel 18 is paid in full, including any applicable agreed upon interest, if any. In some embodiments, the customer 12 has no contractual privity with the initial real estate owner 16 and/or the developer 20 at any point during the method according to the present disclosure.

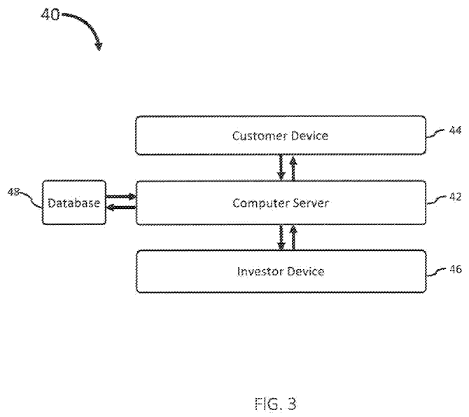

Referring to FIG. 3, an exemplary computer system 40 is shown in accordance with present disclosure. The computer system 40 includes a computer server 42 configured to send and receive information to a customer device 44 and an investor device 46. The computer server 42 is operatively connected to a database 48. The computer server 42 is configured to effectuate at least some steps of the method of FIG. 2. For example, the computer server 42 may receive selection(s) from the customer device 44 indicating the selection of the customer 12 of the selected parcel of real estate 18 and/or the selected building specification. The computer server 42 is configured to send the selection to the investor device 46 and/or store the selection in the database 48. Further, the lease-contract and/or the real estate transfer contract can be distributed, negotiated and/or executed through communications through the computer server 42 with the use of known “e-signature” contractual methods and/or devices. The computer server 42 may store the executed contracts in the database 48. Further, the computer server 42 may record payments made by the customer 12 and provide an estimated date of full price being paid based on price of the selected parcel of real estate 18 entered by the investor or administrator of the computer system 40.

An exemplary lease-contract in accordance with the present disclosure is provided herewith as Appendix A and entitled “Model Tenancy Agreement Gecci—Rent and Buy.” The Appendix A lease-contract includes a plurality of provisions. However, it is within the scope of the present disclosure to have more or less provisions in a lease-contract and/or different substantive provisions than those provided in the exemplary lease-contract of Appendix A. Further, the lease-contract according to the present disclosure may have different lease provisions based on the applicable laws in the jurisdiction of the selected parcels of real estate 18.

An exemplary real estate transfer contract in accordance with the present disclosure is provided herewith as Appendix B. The Appendix B real estate transfer contract may have to be notarized and includes a plurality of provisions. However, it is within the scope of the present disclosure to have more or less provisions in a real estate transfer contract and/or different substantive provisions than those provided in the exemplary real estate transfer contract of Appendix B. Further, the real estate transfer contract according to the present disclosure may have different provisions based on the applicable laws in the jurisdiction of the selected parcels of real estate 18. Similarly, real estate transfer contracts in accordance with the present disclosure may include a plurality of provisions that may differ from contract to contract as desired by the customer 12 and investor 14, and/or as required by law.

Advantageously, embodiments according to the present disclosure may provide customers (buyers) financial security against possible rising costs/prices, and provide investors (sellers) a better possibility of protecting their real estate assets. In some embodiments, the customer (buyer) declares a submission of execution. This prevents that the investor (seller) must go to court if the buyer does not make the promised payments, but is able to enforce the outstanding payments immediately.

In some embodiments, the interest factored into the periodic payments (lease payments) is slightly higher than the key interest rate. The final installment of the periodic payments does not need to be greater than the regular periodic payments. In some embodiments, the execution of the contracts provides the customer with the right of refusal such that the customer is not obligated to acquire ownership in the property. In some embodiments, in the event of termination, none of the previously paid payments by the customer will be refunded.

The present disclosure uses the terms “real estate,” “parcel of real estate” and “property” to describe real property. It is within the scope of the present disclosure for any type of real property to be within the scope of these terms in the methods and systems described herein. For example, the selected parcel of real estate may be a single apartment in a skyscraper building.

While the present disclosure has been illustrated and described with respect to particular embodiments thereof, it should be appreciated by those of ordinary skill in the art that various modifications to this disclosure may be made without departing from the spirit and scope of the present disclosure.

What is claimed is:

1. A method for leasing and transferring real estate comprising the steps of:
selecting, by a customer, one or more parcels of real estate owned by a real estate owner or by an investor and providing said selection to the investor;
determining whether or not development of said one or more selected parcels of real estate is needed or desired and, if development is needed or desired, selecting a building specification by said customer suitable for building on the selected parcel of real estate, providing said selection to the investor, and developing said selected building specification on the one or more selected parcels of real estate;
executing a lease-contract and a real estate transfer contract by said customer and said investor, wherein the lease-contract provides that the investor conveys a leasehold to the customer for the one or more selected parcels of real estate, including one or more of the buildings that have been developed, are being developed or will be developed, wherein the leasehold duration may be indefinite or for a particular duration of time,
wherein the real estate transfer contract provides that the real estate transfer contract is not valid unless one or more condition precedents are satisfied, wherein the real estate transfer contract becomes effective due to the condition precedent of the full price being paid through lease payments being paid by said customer; and
acquiring ownership of the one or more selected parcels of real estate by said customer when the condition precedent are fulfilled.

2. The method according to claim 1, wherein the lease-contract and/or the real estate transfer contract provides that a priority notice of conveyance for the benefit of the customer is entered in the land register.

3. The method according to claim 2, wherein the priority notice of conveyance is registered with a waiver of objection and and/or a waiver of the plea of lapsed time.

4. The method according to claim 1, wherein the investor provides the customer with a catalogue of suitable buildings from which the customer selects a building for the selected one or more parcels of real estate, and wherein a developer develops said selected one or more buildings on the selected parcel of real estate.

5. The method according to claim 1, wherein the duration of time is between 23 and 32 years.

6. The method according to claim 1, wherein the lease-contract provides that utility costs for the selected parcel of real estate are fixed and the customer promises to pay the fixed utility costs, or that the utility costs are subject to an inflation rate or other metric for higher/lower utility costs.

7. The method according to claim 1, wherein the lease-contract and/or the real estate transfer contract provide that the investor has no possibility to terminate the lease-contract and/or the real estate transfer contract as long as the customer is making the promised payments at the promised times.

8. The method according to claim 1, wherein the lease-contract provides that the leasehold to the customer terminates if the customer terminates or breaches the contract and the customer loses all rights concerning the selected parcel of real estate.

9. The method according to claim 1, wherein the building to be developed is a single-family house or a condominium or an apartment or an apartment building or a city block or an entire or part of a city quarter or commercial real estate.

10. The method according to claim 1, wherein the real estate transfer contract does not specify a final payment for the real estate transfer contract to come into effect.

11. The method according to claim 1, wherein the lease-contract provides that the investor conveys a right to sub-lease the selected real estate parcel to a third party via a sub-lease agreement.

12. A system for leasing and transferring real estate comprising a computer system, said computer system including a computer server configured to send and receive information to a customer device and an investor device, said computer server being operatively connected to a database, wherein computer server is configured to receive selection(s) from the customer device indicating the selection of a customer of a selected parcel of real estate and/or of a selected building specification.

13. The system according to claim 12, wherein the computer server is configured to send the selection to the investor device and/or store the selection in the database.

14. The system according to claim 12, wherein the computer server is configured to distribute, negotiate and/or execute a lease-contract and/or a real estate transfer contract with the use of “e-signature” contractual methods and/or devices.
